(19) United States
(12) Patent Application Publication
(10) Pub. No.: US 2005/0272006 A1
(43) Pub. Date: Dec. 8, 2005

(54) Apparatus and method for removal of a dental veneer

(76) Inventor: Jeffrey M. Rosenberg, Wynnewood, PA (US)

Correspondence Address: RATNERPRESTIA, P O BOX 980, VALLEY FORGE, PA, 19482-0980, US

(21) Appl. No.: 10/862,619

(22) Filed: Jun. 7, 2004

(51) Int. Cl. A61C 3/14; A61C 5/04

(52) U.S. Cl. 433/159

(57) ABSTRACT

A device for removing a provisional veneer attached to a tooth comprising: (a) a pair of handles in a hinged relationship for manipulating the device, the handles extending in a proximal direction from a hinge; and (b) a pair of jaws opposite the pair of handles and extending in a distal direction from the hinge. At least one of the jaws of the pair has a provisional veneer-engaging edge extending in a direction generally perpendicular to the direction defined by the distally extending jaws. The edge has a curvature defined as concave with respect to a line perpendicular to the direction defined by the distally extending jaws. Preferably, the device also has a protrusion extending from the jaw to help the curved tip access the veneer. Also included is a method of using the device.

### BACKGROUND OF THE INVENTION

Cosmetic veneers are an established technique in cosmetic dental restoration. Veneers are an alternative to the traditional methods of using a crown, bonding or even losing a tooth. Veneers are usually used on front teeth that have not already been crowned, but could be used on any tooth. The tooth might have been chipped, stained, worn or become non-vital for any of a number of reasons.

Veneers are thin and are made to fit precisely over the surface of a tooth. Although the appearance of a tooth can be changed by using either full crowns or veneers, the main difference between a crown preparation and a veneer preparation is the amount of tooth removed prior to application. Veneers typically involve less tooth removal than a crown. Veneers can be made of different materials, including composites or porcelains. Composite veneer work often involves little or no tooth removal at all. Veneers (also sometimes called porcelain veneers or dental porcelain laminates) are custom-made shells of tooth-colored materials that are designed to cover the front surface of a tooth. Dental veneers are typically made from porcelain or from resin composite materials. These shells are bonded to the front of the teeth changing their color, shape, size or length and resulting in an improved appearance.

The procedure for applying a veneer usually requires three trips to a dentist. The first trip is typically for consultation and the last two are typically for the application process itself. The application process typically involves several steps, including diagnosis and treatment planning, preparation, and bonding of the veneer itself.

To prepare a tooth for a veneer, a dentist will typically remove about 0.5 mm-1.5 mm of enamel from the tooth surface, which is approximately the same as the thickness of the veneer which will be added to the tooth surface. Next, the dentist will make a model or impression of the tooth. This model is sent out to a dental laboratory, which in turn constructs the veneer. Often, as a part of this process, temporary, or provisional veneers, are placed on the tooth between the time the veneer is ordered and the time it is applied.

Provisional veneers are placed with a minimum of adhesive bond (such as a friction, undercut, or low-strength bonding agent). After the tooth is prepared, a temporary or provisional material is applied to the area of preparation. This provisional protects the prepared area, and serves as a prototype for the patient to evaluate the final veneer design (shape, length, position, and color), prior to the time when the final veneer is applied, usually several weeks later.

The provisionals can also serve as a model of the desired final veneer. An alginate impression and/or photograph of the bonded provisional can be sent along with the working impression to improve communication with the manufacturer of the final veneer. Similarly, the provisional veneers may also allow the patient to comment on the shape and feel of the veneer, providing additional insight into the finished product.

Typically, the provisional veneer is removed with brute force, including prying the provisional free, breaking it from the tooth in pieces, or sectioning it with a fine diamond, by first severing the wide interproximal contact, and then following with shallow, coronal midline cuts that allow a steel plastic instrument to pry the halved veneer apart. A back-action crown and bridge remover fitted with the end normally used to engage crown margins has been used to provide assistance. Any remaining resin clinging to the etched spot is typically scraped or shaved off with a fine diamond.

Thus, such prior art methods of provisional removal result in the destruction of the provisional and typically a great deal of effort on the part of the dentist, which increases the time involved and patient discomfort.

### SUMMARY OF THE INVENTION

The present invention provides a pliers-like device for removing a provisional veneer attached to a tooth. The device comprises: (a) a pair of handles in a hinged relationship for manipulating the pliers-like device, the handles extending in a proximal direction from a hinge; and (b) a pair of jaws opposite the pair of handles and extending in a distal direction from the hinge. At least one of the jaws of the pair has a provisional veneer-engaging edge extending in a direction generally perpendicular to the direction defined by the distally extending jaws. The edge has a curvature defined as concave with respect to a line perpendicular to the direction defined by the distally extending jaws. The concave edge has a radius adapted to engage an interface of a provisional veneer and a tooth.

A preferred embodiment of the present invention also includes a protrusion extending from the jaw having the concave edge, the protrusion extending in a direction generally perpendicular to both the direction of the concave edge and the direction defined by the distally extending jaws. The protrusion is adapted to elevate the gum tissue to allow the concave edge of the jaw to contact a provisional veneer at the interface of the provisional veneer and a tooth to which the provisional veneer is attached.

In a most preferred embodiment, the device additionally includes a concave recess extending into the jaw proximal the concave edge and in a direction generally perpendicular to both the direction of the concave edge and the direction defined by the distally extending jaws.

Included as a part of the invention is a method of removing a provisional veneer from a tooth. The method comprises the steps of: (a) contacting the provisional veneer with a curved edge of a pliers-like device at a boundary of an interface between the provisional veneer and the tooth from which the provisional veneer is to be removed; and (b) causing the curved tip of the device to move into the interface between the provisional veneer and the tooth to thereby separate the provisional veneer from the tooth.

A preferred method of the present invention includes modifying a provisional veneer for a tooth. The method comprises the steps of: (a) elevating a gum margin proximal the boundary of a provisional veneer on a tooth with a pliers-like device; (b) contacting the provisional veneer with a curved edge of a pliers-like device at a boundary of an interface between the provisional veneer and the tooth from which the provisional veneer is to be removed; (c) causing the curved edge of the device to move into the interface between the provisional veneer and the tooth to thereby separate the provisional veneer from the tooth; (d) modifying the provisional veneer; and (e) applying the modified provisional veneer back onto the tooth. Preferably, this method is accomplished with the tool of the present invention which can apply a shearing force to the provisional veneer, minimizing tooth destruction and expediting the removal process.

### BRIEF DESCRIPTION OF THE DRAWINGS

The features of the invention believed to be novel and the elements characteristic of the invention are set forth with particularity in the claims. The figures are for illustration purposes only and are not necessarily drawn to scale. The invention itself, however, both as to the device and method of operation, may best be understood by reference to the detailed description which follows taken in conjunction with the accompanying drawing in which:

FIG. 1 is an angled view of a device in accordance with the present invention;

FIG. 2 is a side view of a device in accordance with the present invention;

FIG. 3 is a close-up view of the tips shown encircled in FIG. 2;

FIG. 4 is a top view of the tip shown in FIG. 3;

FIG. 5 is an illustration of the use of a device in accordance with the prior art;

FIG. 6 is a top view of the use of a device in accordance with the prior art;

FIG. 7 is an illustration of the device in accordance with the present invention being used in the method of the present invention whereby the gum is moved as the device is moved into position to remove a provisional veneer;

FIG. 8 is a top view of the use of the device of the present invention;

FIG. 9 is an angled view of an alternative embodiment of the device in accordance with the present invention;

FIG. 10 is a side view of the device shown in FIG. 9;

FIG. 11 is an illustration of the removal of the veneer in accordance with the present invention which involves a tool having an anatomic curve to engage the veneer; and

FIG. 12 shows the removal of a provisional veneer according to a device and method of the present invention.

### DETAILED DESCRIPTION OF THE INVENTION

The present invention provides a method and apparatus for removing a provisional veneer from a patient's tooth. The apparatus and method allows for the removal in such a manner that the provisional veneer is not destroyed. Although the provisional veneer is just that, provisional (temporary), it may be that the need arises that it be replaced until the final veneer is ready, such as if the final veneer is not properly made or does not have the physical properties or visual characteristics that were expected. An additional advantage to the present invention's apparatus and method is the concomitant ease with which the provisional veneer can be removed. This ease shortens both the time needed for removal and the discomfort of the patient.

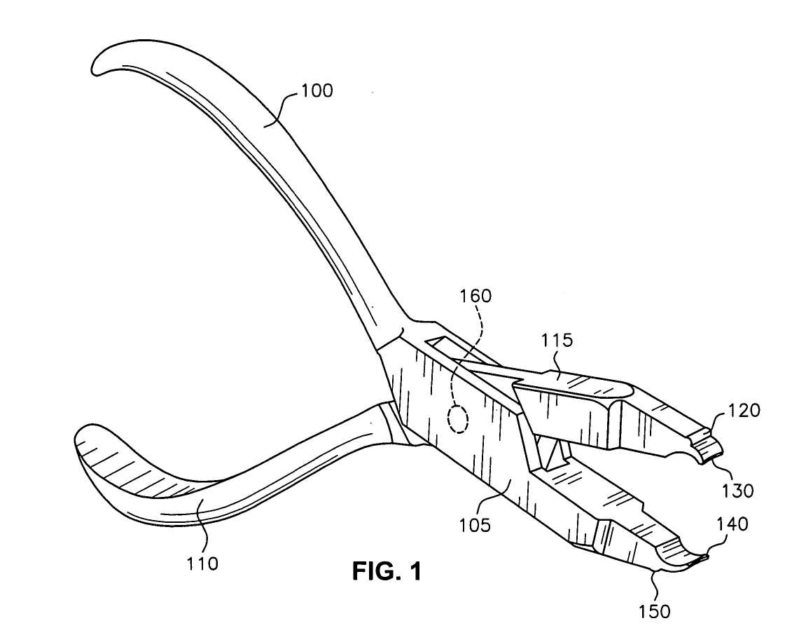

An exemplary device in accordance with the present invention is shown in FIG. 1. The device shown has two jaws and two handles, partially open with respect to each other. Specifically, FIG. 1 shows handle 100 connected to jaw 105 and handle 110 connected to jaw 115. In this embodiment, jaw 115 has a protrusion 120 extending in a direction generally perpendicular to both the direction defined by edge 130 and the direction defined by the distally extending jaws. Protrusion 120 is adapted to elevate a gum margin prior to contacting the edge of a provisional veneer with concave edge 130. In a preferred embodiment, as shown in FIG. 1, the opposite jaw having concave edge 140 also has a protrusion, namely protrusion 150.

In this and other embodiments herein described, the handles are defined as extending in a direction generally proximal from a hinge and the jaws are defined as extending in a direction generally distal the hinge.

Although the embodiment shown in FIG. 1 also has jaw 105 ending distally with a concave edge 140, both jaws do not have to have such a finish. It could be that only one of the two jaws has a concave edge, and the other jaw has any jaw tip configuration known in the art, such as a spike, a pin, a soft, padded surface, or any of a number of other known dental tool tip types. Preferably, however, both jaws have the concave edge later described.

Shown in dashed lines in FIG. 1 is a pivot point, or hinge, 160, which is not seen normally but exists inside jaw 105 which joins the two handle/jaw halves and allows for the pivotal connection of the pair of handles in a hinged relationship with respect to one another. Such pivot means allows a user to move the pair of jaws toward and away from one another in response to pivotal movement of the handles with respect to one another.

In a preferred embodiment of the device of the present invention, at least the jaws are made from titanium, and most preferably the entire device is made of titanium. Other materials, such as stainless steel, may be used, so long as the material selected is of sufficient hardness and capable of being sterilized by known techniques such as autoclaving, etc.

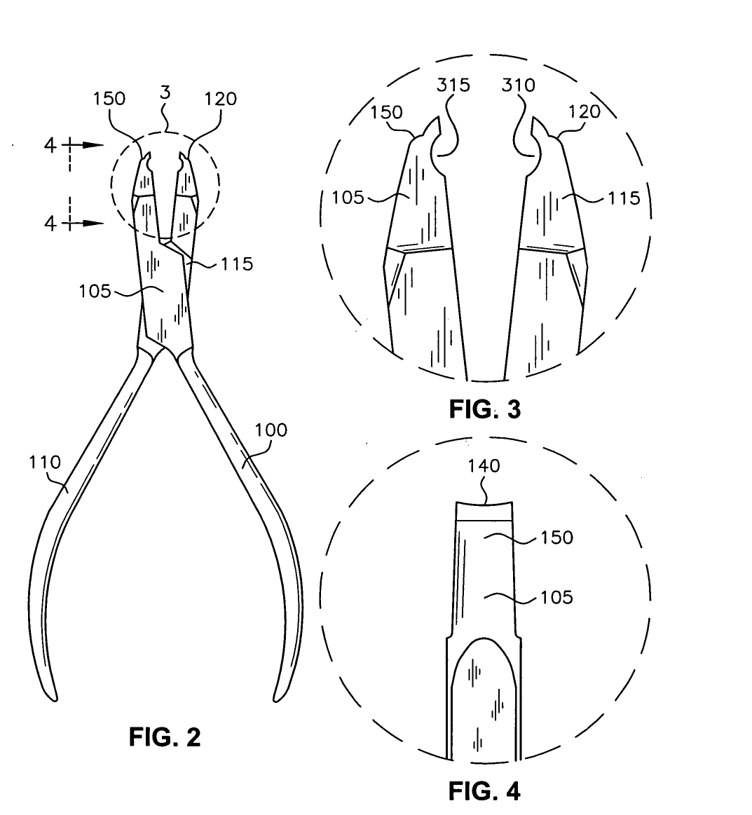

FIG. 2 shows the preferred embodiment of the invention as illustrated in FIG. 1 but from a side view. As noted above with respect to FIG. 1, handles 100 and 110 are connected to jaws 105 and 115, respectively. FIG. 3 shows a close-up view of the portion of the device encircled in FIG. 2 and labeled 3. FIG. 3 illustrates the distal tips of jaws 115 and 105 having protrusions 120 and 150, respectively. FIG. 3 also shows recesses 310 and 315 in the distal tips of jaws 115 and 105, respectively.

Recesses 310 and 315 are optional, but are present in the most preferred embodiment. Preferably, they have a radius of from 20° to 50°, and more preferably from 30° to 45°. These recesses are used to hold the provisional veneer in place once it is removed from the tooth. This aspect is discussed in more detail below in the discussion of the method of the present invention.

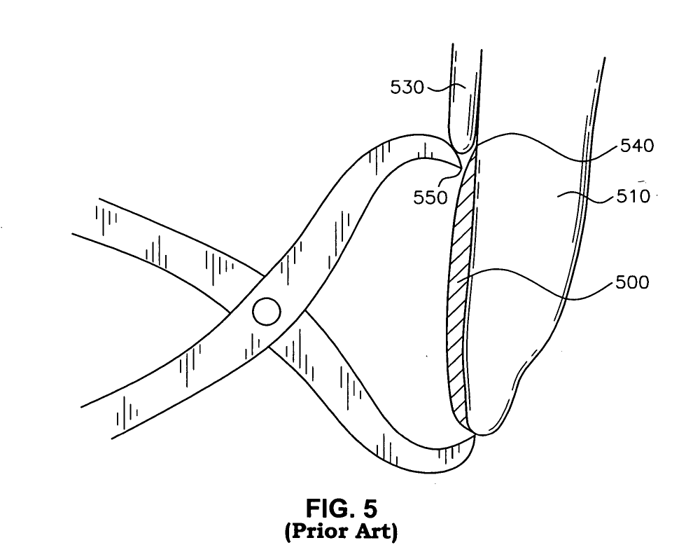

FIG. 4 illustrates a partial top view of a pliers-like device in accordance with the invention. Specifically, FIG. 4 shows the distal most tip of jaw 105, and its concave edge 140. This edge is important and its advantages will be discussed in more detail below. Generally, however, this edge has a radius of from 10° to 35°, and preferably from 15° to 25°. This concave edge provides an anatomically formed edge to match the curvature of the tooth at a point where the provisional veneer would end. This configuration allows for a good match-up between the jaw edge and the boundary of the provisional veneer/tooth interface proximate the gum margin.

FIG. 5 shows a device of the prior art being used in an attempt to grasp and remove a provisional veneer 500 from tooth 510. This device does not have a concave edge, nor does it have a protrusion as defined above. As can be seen, gum 530 extends down at a point proximal the upper boundary 540 of the veneer 500/tooth 510 interface. Because gum 530 is in the way, a patient's gum is likely to be damaged or otherwise irritated by the tip of the device shown in FIG. 5 as the distal most tip 550 of the device of FIG. 5 is moved to boundary 540.

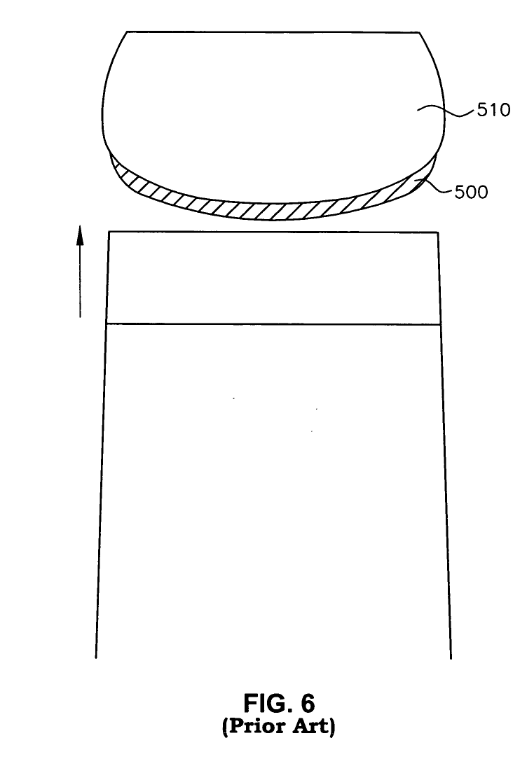

Still another problem with the prior art is that tooth 510 is not flat on its front surface. This means that provisional veneer 500 is also not flat, and specifically that the boundary between the interface between provisional veneer 500 and tooth 510 is not flat. This can be seen well in the overhead view presented in FIG. 6. When a tool with a flat front, such as is shown in FIG. 6, is used to attempt to remove provisional veneer 500, it only can touch part of the boundary. If it is inserted straight toward tooth 510, as is shown by the arrow in FIG. 6, it will only touch some mid-section of the boundary, such as a point in the middle or tangential to the radius of the tooth. By then applying a compressive force on the device handles, a force only in the mid-section of the boundary is applied. This would often lead to cracking, breaking, and destruction of the provisional veneer, not to mention only partial removal. This process would be repeated until all of the provisional was essentially scraped off of the tooth, bit by bit.

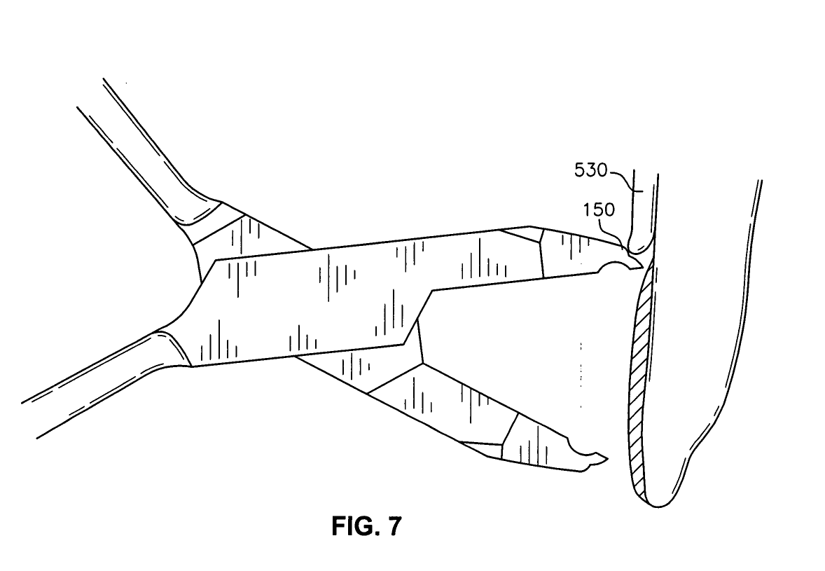

The devices and methods of the present invention solve these problems. As noted above, a preferred device of the present invention includes protrusion 150 as shown in FIG. 7. In use, and consistent with the method of this invention described in more detail below, as jaw 105 is moved into place whereby its distal tip is placed proximal the boundary of the provisional veneer/tooth interface, the configuration of the jaw allows for the gum 530 to be pushed out of position just slightly so as to provide access by the jaw tip to the boundary of the provisional veneer/tooth interface. The protrusion allows both a surface upon which the gum can be rested and moved out of the way, and at the same time strengthens the jaw tip so that the ultimate distal tip can be thin enough to approach the provisional veneer/tooth interface boundary without undue mass of the tip interfering with the gum. In other words, the protrusion achieves both of these functions, which together provide a jaw tip which solves the problem of gum irritation and interference as noted above with respect to FIG. 5.

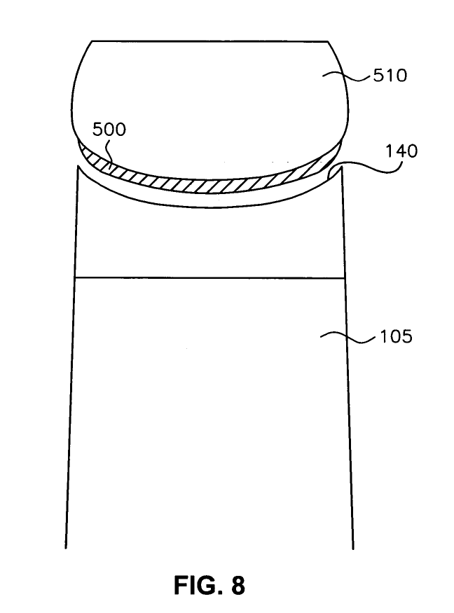

Still another aspect of the present invention, and as noted above particularly with respect to FIG. 4, is concave edge 140. This edge is designed to match closely the anatomical curve of the tooth, provisional veneer, and thereby the curvature of the interface between the tooth and provisional veneer. FIG. 8 illustrates this overhead view of the tip in accordance with the invention whereby concave tip 140 of jaw 105 is about to be applied to the upper boundary 540 between tooth 410 and provisional veneer 400. Unlike the case of the prior art shown in FIG. 4, this tip will contact the boundary along its entire interface. As the handles of the device are compressed and the jaws brought together, the tip will apply a constant force along the entire interface, thereby removing the provisional veneer in one piece.

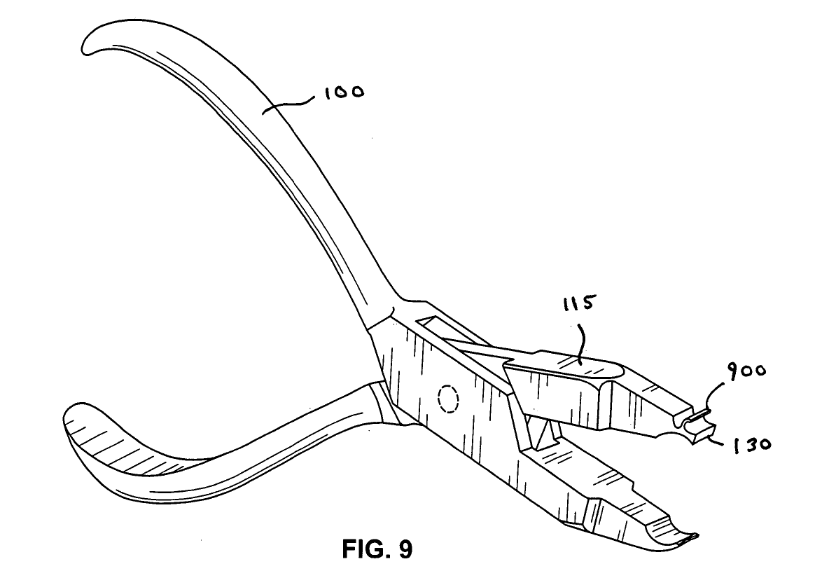

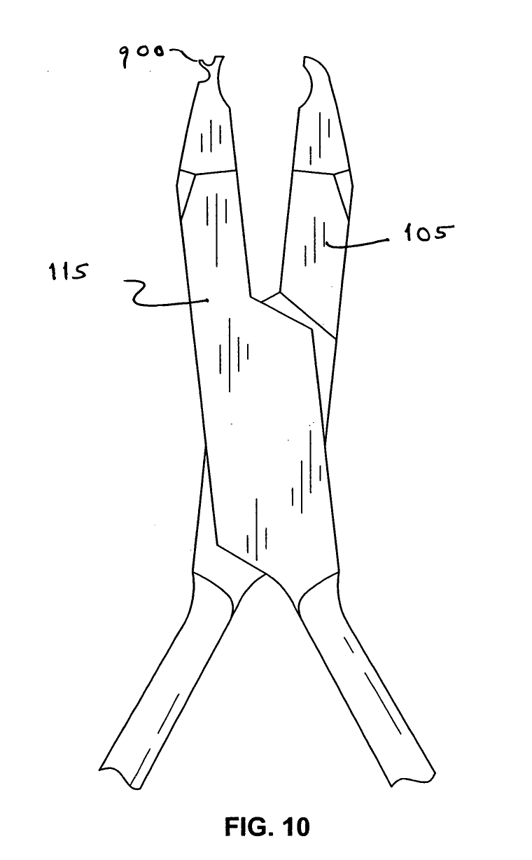

A preferred embodiment of the device according to the present invention is shown in FIGS. 9 and 10, which illustrate protrusion 900 that extends in a direction generally perpendicular to both the direction of the concave edge and the direction defined by the distally extending jaws. In this embodiment, protrusion 900 is curved slightly, but like the embodiment shown in FIG. 1, is adapted to elevate a gum to allow the concave edge of the jaw (edge 130) to contact a provisional veneer at the interface of the provisional veneer and a tooth to which the provisional veneer is attached.

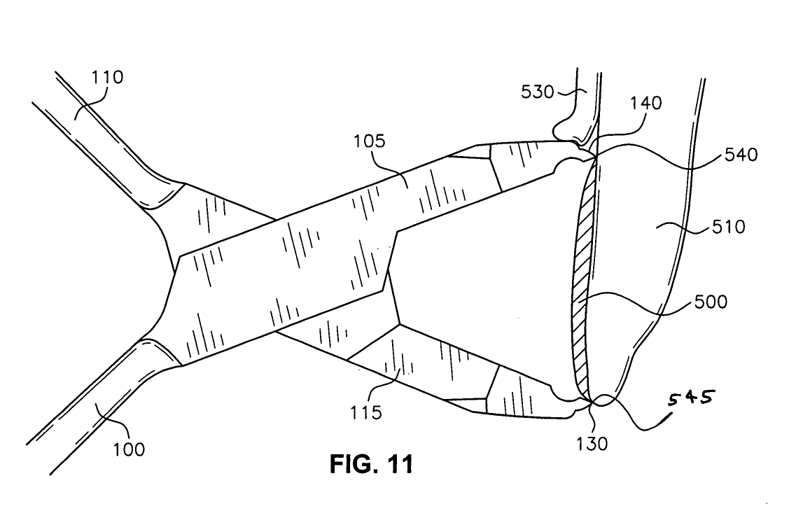

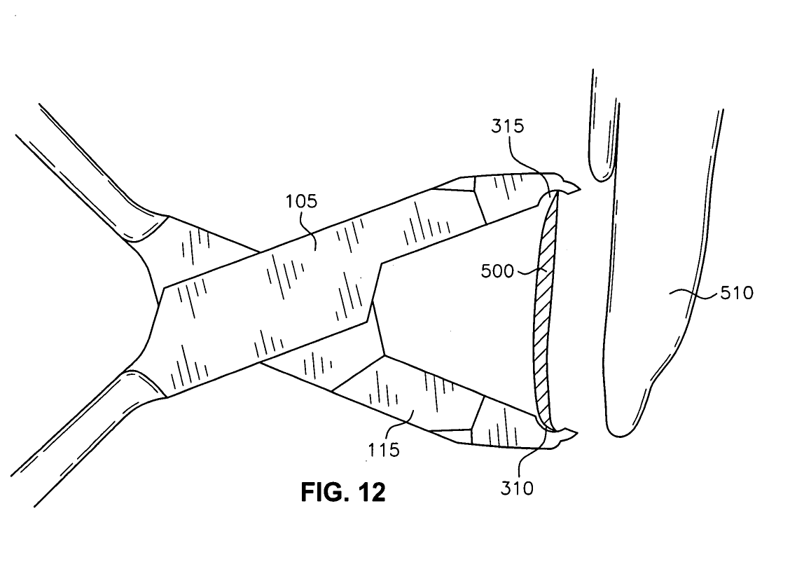

The preferred embodiment of the method of provisional veneer removal in accordance with the present invention is seen in FIGS. 11 and 12. FIG. 11 shows gum 530 held safely out of the way such that concave edge 140 can contact veneer 500 right at its boundary 540. In this embodiment, concave edge 130 is placed at the opposite boundary 545 of veneer 500, and the device is ready to be compressed and separate veneer 500 from tooth 510.

As noted above, both jaws do not have to have the concave tip or protrusion. However, in a preferred embodiment, at least one jaw has both the protrusion and concave tip, and most preferably both tips have both the protrusion and concave tip. This allows for the user (e.g., dentist or practitioner) to be free to not worry about which side of the device he is placing at the upper boundary and which he is placing at the bottom. Furthermore, the anatomical, concave edge feature of the preferred embodiment is beneficial at both ends of the provisional veneer. FIG. 11 shows an embodiment where both edges are concave, and both have a protrusion.

As shown in FIG. 11, the device is ready to be compressed and remove veneer 500. Because of the features of the present invention described above, the veneer can now be removed in one piece as handles 100 and 110 are carefully compressed to cause the distal end of jaw 105 to move into the interface between veneer 500 and tooth 510 to thereby separate the provisional veneer from the tooth with a shearing type force. Because of the placement and insertion of the edge of the device described into the interface between the veneer and tooth, a separating force which is essentially parallel to the interface (e.g., a shearing force) pries the veneer free and keeps the veneer in one piece. FIG. 12 shows the result of the user compressing handles 100 and 110 to shearingly remove veneer 500, in one piece, from tooth 510. Note here that gum 530 has returned, unharmed, to its natural position.

The ability to remove the provisional veneer in one piece is important for several reasons. As noted above, the decreased time and stress of scraping the provisional veneer off the patient's tooth is advantageous. Another key advantage is the ability for the dentist to replace the provisional veneer back onto the tooth should the final veneer itself not fit properly or otherwise not be adequate for final placement. In such a case, it is also possible to modify the provisional veneer should the patient conclude after wearing the provisional veneer for a week or two that additional changes should be made. In such a case, the provisional can be so modified and reapplied to the patient's tooth for an additional, temporary test period.

Although the invention is illustrated and described herein with reference to specific embodiments, the invention is not intended to be limited to the details shown. Rather, various modifications may be made in the details within the scope and range of equivalents of the claims and without departing from the invention.

1. A pliers-like device for removing a provisional veneer attached to a tooth, the device comprising:
(a) a pair of handles in a hinged relationship for manipulating the pliers-like device, the handles extending in a proximal direction from a hinge; and
(b) a pair of jaws opposite the pair of handles and extending in a distal direction from the hinge, at least one of the jaws of the pair having a provisional veneer-engaging edge extending in a direction generally perpendicular to the direction defined by the distally extending jaws, the edge having a curvature defined as concave with respect to a line perpendicular to the direction defined by the distally extending jaws, the concave edge having a radius adapted to engage an interface of a provisional veneer and a tooth.

2. The device of claim 1 further comprising a protrusion extending from the at least one jaw having the concave edge, the protrusion extending in a direction generally perpendicular to both the direction of the concave edge and the direction defined by the distally extending jaws, the protrusion adapted to elevate a gum to allow the concave edge of the jaw to contact a provisional veneer at the interface of the provisional veneer and a tooth to which the provisional veneer is attached.

3. The device of claim 1 or 2 wherein the at least one jaw having the concave edge further comprises a concave recess extending into the jaw proximal the concave edge and in a direction generally perpendicular to both the direction of the concave edge and the direction defined by the distally extending jaws.

4. The device of claim 1 wherein each jaw is titanium.

5. The device of claim 1 comprised of titanium.

6. The device of claim 1 wherein both jaws have a concave edge.

7. The device of claim 2 wherein both jaws have the concave edge and both jaws have a protrusion.

8. The device of claim 1 wherein the concave edge has a radius of 10° to 35°.

9. The device of claim 8 wherein the concave edge has a radius of 15° to 25°.

10. The device of claim 3 wherein the concave recess has a radius of 20° to 50°.

11. The device of claim 3 wherein the concave recess has a radius of 30° to 45°.

12. A method of removing a provisional veneer from a tooth, the method comprising the steps of:
(a) contacting the provisional veneer with a curved edge of a pliers-like device at a boundary of an interface between the provisional veneer and the tooth from which the provisional veneer is to be removed; and
(b) causing the curved tip of the device to move into the interface between the provisional veneer and the tooth to thereby separate the provisional veneer from the tooth.

13. The method of claim 12 wherein step (b) comprises closing handles on the pliers-like device to move jaws of the pliers toward one another.

14. The method of claim 12 further comprising the step of, before step (a), elevating the gum margin proximal the boundary of the provisional veneer with the pliers-like device.

15. The method of claim 12 further comprising the steps of:
(c) modifying the provisional veneer; and
(d) applying the modified provisional veneer back onto the tooth.

16. The method of claim 12 wherein step (a) includes contacting the veneer on both an upper boundary with one jaw and a lower boundary with the other jaw, and step (b) includes applying a force into the interface at each boundary tangential to the surface of the tooth at each boundary.

17. A method of modifying a provisional veneer for a tooth, the method comprising the steps of:
(a) elevating a gum margin proximal the boundary of a provisional veneer on a tooth with a pliers-like device;
(b) contacting the provisional veneer with a curved edge of a pliers-like device at a boundary of an interface between the provisional veneer and the tooth from which the provisional veneer is to be removed;
(c) causing the curved edge of the device to move into the interface between the provisional veneer and the tooth to thereby separate the provisional veneer from the tooth;
(d) modifying the provisional veneer; and
(e) applying the modified provisional veneer back onto the tooth.
